(19) United States
(12) Patent Application Publication
(10) Pub. No.: US 2010/0216453 A1
(43) Pub. Date: Aug. 26, 2010

(54) COMPENSATING FOR CELL OUTAGE USING PRIORITIES

(75) Inventors: Harald KALLIN, Sollentuna (SE); Johan Moe, Mantorp (SE)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON, Stockholm (SE)

(21) Appl. No.: 12/390,080

(22) Filed: Feb. 20, 2009

(51) Int. Cl. H04W 24/00; H04W 4/00

(52) U.S. Cl. 455/424; 455/434

(57) ABSTRACT

A device receives information associated with multiple cells, and determines a priority for each of the multiple cells based on the received information. The device also assigns each of the determined priorities to a corresponding one of the multiple cells, detects an outage associated with one of the multiple cells, and provides a temporary service to the one of the multiple cells from one or more adjacent cells with priorities less than or equal to the priority assigned to the one of the multiple cells.

### TECHNICAL FIELD

Embodiments described herein relate generally to communication systems, and, more particularly, to compensating for a cell outage in a telecommunication system using priorities.

### BACKGROUND

Sometimes a cell (or base station) in a cellular network is unable to provide any service (or only limited service). This is called a “cell outage,” a “service outage,” or an “out of service cell” and is hopefully only a temporary mishap. A cell experiencing a cell outage may overlap with other cells in the cellular network (e.g., cells provided adjacent to the affected cell). Due to such overlaps, the other cells (also referred to as “helper cells”) are, to some extent, capable of handling traffic to and from user equipment (e.g., mobile telephones) in the affected cell's area. There are also other mechanisms that alleviate the negative impact on the service provided to user equipment in the affected cell's area. For example, the user equipment may seek cell coverage from other radio technologies (e.g., a wideband code division multiple access (WCDMA)-based user equipment may seek service from a global system for mobile communications (GSM)-based network). The WCDMA-based user equipment selects a best cell that it can receive from the GSM-based network. However, the service from the GSM-based network may not meet an end user's expectations (e.g., no video calls would be possible with the GSM-based network).

For some unfortunate users in a cell experiencing a cell outage, there may be no other detectable cells (or base stations) within range of the affected users. Such users may not receive any service or may receive only marginal service. One proposed solution to improve service for such users includes changing configurations of cells surrounding an affected cell to improve cell coverage and service in the affected cell's area. Such changes may include increasing an output power, changing an antenna direction (e.g., tilt, azimuth, or height), etc. associated with one or more base stations of the surrounding cells.

There are several reasons that cause a cell (or base station) to go out of service, and different reasons provide different impacts on the service provided by the out of service cell. In one example, an out of service cell (or base station) may experience a total cell failure (e.g., where no service is received from the cell) due to loss of electrical power, transport failure, antenna failure, failure of non-redundant equipment, etc. In another example, an out of service cell (or base station) may experience a partial cell failure (e.g., where limited service is received from the cell) due to partial transport failure, reduced transmit power, loss of receiver capabilities, reduced processing capabilities, etc.

However, implementing major, automatic changes for an out of service cell in a cellular network (e.g., such as modifying the output power or changing the antenna configuration of a surrounding base station) can have adverse effects on users that are normally served by a helper cell that is also attempting to serve an out of service cell. In other words, service problems experienced by users in the out of service cell propagate to users associated with the helper cells.

In some cases, this is an acceptable solution since the service provided to the users in out of service cell area is now shared with the helper cells. In other cases, this is not an acceptable solution since some cells are more important than other cells. For example, it may not be acceptable to reallocate resources from cells serving busy areas, government buildings, major business parks, transportation locations (e.g., railroad stations, airports, etc.), main highway arteries, etc. to ordinary cells (e.g., cells serving other areas, such as less busy areas) experiencing a cell outage. However, it may be acceptable to steer away resources from ordinary cells to cells experiencing a cell outage and serving busy areas, government buildings, major business parks, transportation locations, main highway arteries, etc.

### SUMMARY

It is an object of the invention to overcome at least some of the above disadvantages, and to provide priorities to cells (e.g., based on time of day information, cell load information, etc.) so that it may be determined if a helper cell should serve users associated with an out of service cell.

Embodiments described herein may provide systems and/or methods that assign priorities to cells in a cellular network based on a variety of factors (e.g., distance information, cell load information, etc). The systems and/or methods may utilize two or more priority levels (e.g., a low priority, a medium priority, a high priority, etc.) when assigning priorities to the cells. If a cell outage occurs (or a cell experiences an overload condition, etc.), the systems and/or methods may use the assigned priorities to determine if a helper cell (e.g., assigned a priority) should attempt to serve users associated with an out of service cell (e.g., assigned a same or different priority than the helper cell). For example, the systems and/or methods may assign a high priority to one cell of the cellular network and a low priority (e.g., lower than high priority) to another cell of the cellular network. In such an arrangement, if the high priority cell experiences a service outage, the systems and/or methods may provide temporary service, via the low priority cell, to users associated with the high priority cell. If the low priority cell experiences a service outage, the systems and/or methods may not provide temporary service, via the high priority cell, to users associated with the low priority cell. Alternatively and/or additionally, the systems and/or methods may provide temporary service, via the high priority cell, to the users associated with the low priority cell when the high priority cell is lightly loaded.

In one exemplary implementation of this embodiment, the systems and/or methods may receive information (e.g., business information, time information, cell load information, distance information, etc.) associated with a cell in a cellular network, may determine a priority for the cell based on the received information, and may assign the determined priority to the cell. The systems and/or methods may detect a service outage associated with the cell, and may provide temporary service to the cell from one or more adjacent cells with priorities that are less than or equal to the priority assigned to the out of service cell.

In another exemplary implementation of this embodiment, the systems and/or methods may determine cell priorities among various technologies (e.g., Long Term Evolution (LTE), WCDMA, GSM, etc.). For example, if an LTE-based cell is disabled and the cell area is also covered by GSM and/or WCDMA, the systems and/or methods may adjust the GSM or WCDMA-based cells (e.g., adjust cell size via power, tilt, handover parameters, etc.) in order to provide service for the disabled LTE-based cell.

Systems and/or methods described herein may enable a network (e.g., a cellular network) to control or limit fault propagation from an out of service cell into other cells of the network, and to automatically correct the out of service cell. By introducing cell priorities, the systems and/or methods may enable the network (and/or the network operator) to take business aspects associated with the network (e.g., certain cells may support busy and/or important areas) into account when deciding actions that may negatively impact service provided by healthy cells in the network.

### BRIEF DESCRIPTION OF THE DRAWINGS

FIG. 1 depicts a diagram of an exemplary network in which systems and/or methods described herein may be implemented;

FIG. 2 illustrates a diagram of exemplary components of a base station depicted FIG. 1;

FIG. 3 depicts a diagram of exemplary components of a radio network controller (RNC) illustrated in FIG. 1;

FIG. 4 illustrates a diagram of exemplary components of a domain manager depicted in FIG. 1;

FIG. 5 depicts a diagram of exemplary interactions among components of an exemplary portion of the network illustrated in FIG. 1;

FIG. 6 illustrates a diagram of exemplary information capable of being received and/or generated by a component of an exemplary portion of the network depicted in FIG. 1;

FIGS. 7A-7D depict diagrams of exemplary interactions among components of an exemplary portion of the network illustrated in FIG. 1; and

FIGS. 8-12 illustrate flow charts of an exemplary process for assigning priorities to cells and for providing temporary service to out of service cells based on the assigned priorities according to embodiments described herein.

### DETAILED DESCRIPTION

The following detailed description refers to the accompanying drawings. The same reference numbers in different drawings may identify the same or similar elements. Also, the following detailed description does not limit the invention.

Embodiments described herein may provide systems and/or methods that provide priorities to cells (e.g., based on time of day information, cell load information, etc.) so that it may be determined if a helper cell should serve users associated with an out of service cell.

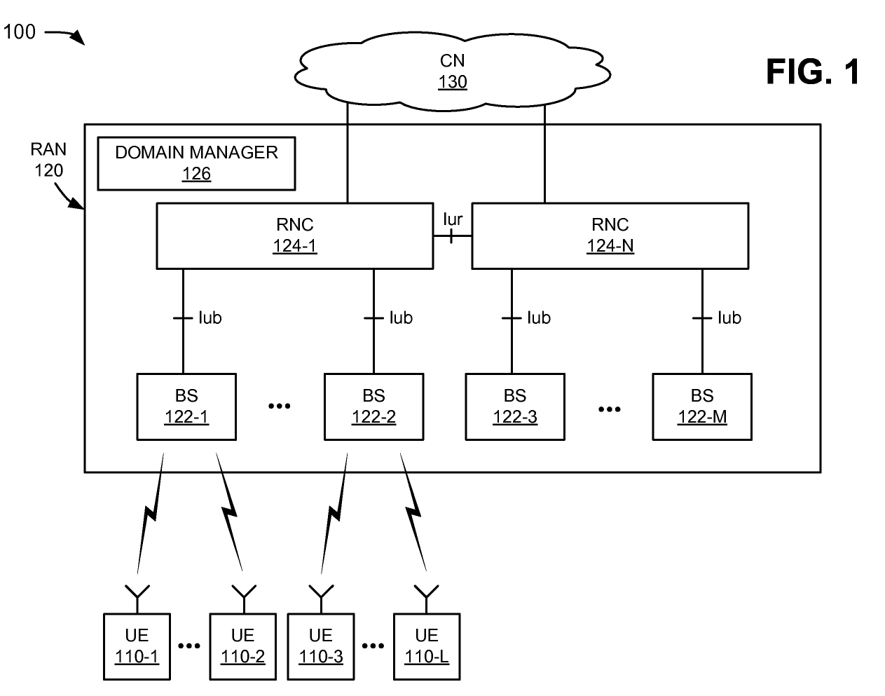

FIG. 1 depicts a diagram of an exemplary network 100 in which systems and/or methods described herein may be implemented. As shown, network 100 may include a group of user equipment (UE) 110-1 through 110-L (referred to collectively, and in some instances individually, as “user equipment 110”), a radio access network (RAN) 120, and a core network (CN) 130. Four pieces of user equipment 110, a single radio access network 120, and a single core network 130 have been illustrated in FIG. 1 for simplicity. In practice, there may be more user equipment 110, radio access networks 120, and/or core networks 130. Also, in some instances, a component in network 100 (e.g., one or more of user equipment 110, radio access network 120, and core network 130) may perform one or more functions described as being performed by another component or group of components in network 100. In one embodiment, network 100 may include different devices than depicted in FIG. 1, may support different standards (e.g., Long Term Evolution (LTE), etc.), and may use different terminology (e.g., a base station controller (BSC) instead of a radio network controller (RNC), etc.).

User equipment 110 may include one or more devices capable of sending/receiving voice and/or data to/from radio access network 120. User equipment 110 may include, for example, a radiotelephone, a personal communications system (PCS) terminal (e.g., that may combine a cellular radiotelephone with data processing and data communications capabilities), a personal digital assistant (PDA) (e.g., that can include a radiotelephone, a pager, Internet/intranet access, etc.), a laptop computer, etc.

Radio access network 120 may include one or more devices for transmitting and/or receiving voice and/or data to user equipment 110 and core network 130. As illustrated, radio access network 120 may include a group of base stations (BSs) 122-1 through 122-M (referred to collectively as “base stations 122” and in some instances, individually as “base station 122”), a group of radio network controllers (RNCs) 124-1 through 124-N (referred to collectively as “radio network controllers 124” and in some instances, individually as “radio network controller 124”), and a domain manager 126. Four base stations 122, two radio network controllers 124, and a single domain manager 126 are shown in FIG. 1 for simplicity. In practice, there may be more or fewer base stations 122 and/or radio network controllers 124, and more domain managers 126. Also, in some instances, a component in radio access network 120 (e.g., one or more of base stations 122, radio network controllers 124, and domain manager 126) may perform one or more functions described as being performed by another component or group of components in radio access network 120.

Base stations 122 (also referred to as “Node Bs”) may include one or more devices that receive voice and/or data from radio network controllers 124 and transmit that voice and/or data to user equipment 110 via an air interface. Base stations 122 may also include one or more devices that receive voice and/or data from user equipment 110 over an air interface and transmit that voice and/or data to radio network controllers 124 or other user equipment 110. In one embodiment, each of base stations 122 may generate one or more cells (e.g., in network 100) that may provide service to one or more user equipment 110.

Radio network controllers 124 may include one or more devices that control and manage base stations 122. Radio network controllers 124 may also include devices that perform data processing to manage utilization of radio network services. Radio network controllers 124 may transmit/receive voice and data to/from base stations 122, other radio network controllers 124, and/or core network 130.

A radio network controller 124 may act as a controlling radio network controller (CRNC), a drift radio network controller (DRNC), or a serving radio network controller (SRNC). A CRNC may be responsible for controlling the resources of a base station 122. On the other hand, an SRNC may serve particular user equipment 110 and may manage connections towards that user equipment 110. Likewise, a DRNC may fulfill a similar role to the SRNC (e.g., may route traffic between a SRNC and particular user equipment 110).

As illustrated in FIG. 1, a radio network controller 124 may connect to a base station 122 via an Iub interface and to another radio network controller 124 via an Iur interface.

Core network 130 may include one or more devices that transfer/receive voice and/or data to a circuit-switched and/or packet-switched network. In one embodiment, core network 130 may include, for example, a Mobile Switching Center (MSC), a Gateway MSC (GMSC), a Media Gateway (MGW), a Serving General Packet Radio Service (GPRS) Support Node (SGSN), a Gateway GPRS Support Node (GGSN), and/or other devices.

In one embodiment, network 100 may include one or more other devices not shown in FIG. 1. For example, network 100 may include an operation and support system (OSS) and/or a network manager. The OSS may include one or more devices that control and manage base stations 122, and that perform data processing to manage utilization of radio network services. The OSS may transmit/receive voice and data to/from base stations 122, other OSSs, and/or the network manager. The OSS may support processes such as maintaining network inventory, provisioning services, configuring network components, and/or managing faults. In one embodiment, the OSS may provide services for network 100, such as order processing, accounting, billing and cost management, network inventory, service provision, network design, network discovery and reconciliation, trouble and fault management, capacity management, network management, field service management, etc.

The network manager may include one or more devices that monitor and administer network 100. The network manager may provide services, such as operation, maintenance, administration, and/or provisioning of network 100. With regard to operation of network 100, the network manager may ensure that network 100 operates smoothly, may monitor for any faults that may occur during operation of network 100, and may try to catch and fix the faults before any users of network 100 are affected by the faults. With regard to administration of network 100, the network manager may track resources associated with network 100 and may determine how the resources are assigned to the users of network 100. The network manager may provide maintenance of network 100 by handling upgrades and repairs that are needed for components of network 100 and by adjusting device configuration parameters so that network 100 operates more smoothly. The network manager may provide provisioning of network 100 by configuring the resources in network 100 to support new customers that may need a service provided by network 100. In one embodiment, the network manager may control, plan, allocate, deploy, coordinate, and monitor the resources of network 100, and may provide network planning, frequency allocation, predetermined traffic routing to support load balancing, configuration management, accounting management, bandwidth management, performance management, security management, and/or fault management for network 100. In another embodiment, the network manager may perform the function of domain manager 126 and may replace domain manager 126.

In one exemplary embodiment, a device, such as one or more of base stations 122, radio network controllers 124, domain manager 126, the OSS, and/or the network manager may perform operations described herein. For example, the device may receive information (e.g., business information, time information, cell load information, distance information, etc.) associated with a cell in network 100 (e.g., provided by one of base stations 122), may determine a priority for the cell based on the received information, and may assign the determined priority to the cell. The device may detect a service outage associated with the cell, and may provide temporary service to the cell from one or more adjacent cells with priorities that are less than or equal to the priority assigned to the cell.

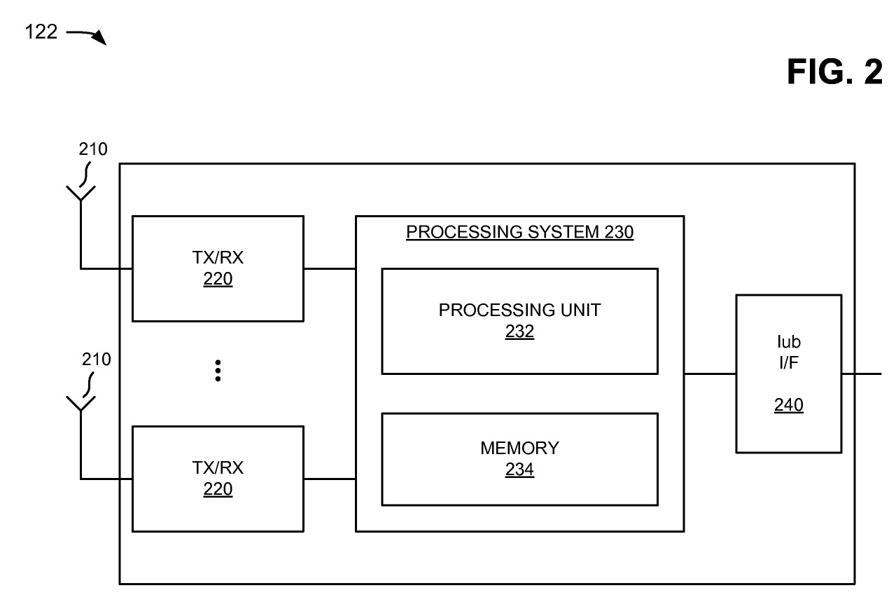

FIG. 2 illustrates a diagram of exemplary components of base station 122. As shown in FIG. 2, base station 122 may include antennas 210, transceivers (TX/RX) 220, a processing system 230, and an Iub interface (I/F) 240.

Antennas 210 may include one or more directional and/or omni-directional antennas. Transceivers 220 may be associated with antennas 210 and may include transceiver circuitry for transmitting and/or receiving symbol sequences in a network, such as network 100, via antennas 210.

Processing system 230 may control the operation of base station 122. Processing system 230 may also process information received via transceivers 220 and Iub interface 240. Processing system 230 may further measure quality and strength of a connection, may determine the distance to user equipment, and may transmit this information to radio network controller 124. As illustrated, processing system 230 may include a processing unit 232 and a memory 234.

Processing unit 232 may include one or more processors, microprocessors, application specific integrated circuits (ASICs), field programmable gate arrays (FPGAs), or the like. Processing unit 232 may process information received via transceivers 220 and Iub interface 240. The processing may include, for example, data conversion, forward error correction (FEC), rate adaptation, Wideband Code Division Multiple Access (WCDMA) spreading/dispreading, quadrature phase shift keying (QPSK) modulation, etc. In addition, processing unit 232 may transmit control messages and/or data messages, and may cause those control messages and/or data messages to be transmitted via transceivers 220 and/or Iub interface 240. Processing unit 232 may also process control messages and/or data messages received from transceivers 220 and/or Iub interface 240.

Memory 234 may include a random access memory (RAM), a read-only memory (ROM), and/or another type of memory to store data and instructions that may be used by processing unit 232.

Iub interface 240 may include one or more line cards that allow base station 122 to transmit data to and receive data from a radio network controller 124 and other devices in network 100.

As described herein, base station 122 may perform certain operations in response to processing unit 232 executing software instructions of an application contained in a computer-readable medium, such as memory 234. A computer-readable medium may be defined as a physical or logical memory device. A logical memory device may include memory space within a single physical memory device or spread across multiple physical memory devices. The software instructions may be read into memory 234 from another computer-readable medium or from another device via antennas 210 and transceivers 220. The software instructions contained in memory 234 may cause processing unit 232 to perform processes described herein. Alternatively, hardwired circuitry may be used in place of or in combination with software instructions to implement processes described herein. Thus, embodiments described herein are not limited to any specific combination of hardware circuitry and software.

Although FIG. 2 shows exemplary components of base station 122, in other embodiments, base station 122 may contain fewer, different, differently arranged, or additional components than depicted in FIG. 2. In still other embodiments, one or more components of base station 122 may perform one or more other tasks described as being performed by one or more other components of base station 122.

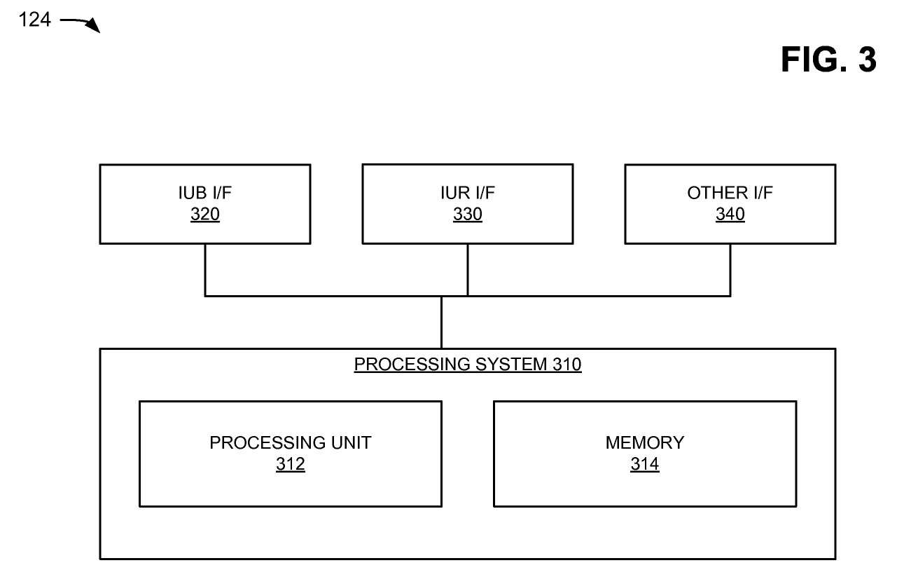

FIG. 3 depicts a diagram of exemplary components of radio network controller 124. As shown in FIG. 3, radio network controller 124 may include a processing system 310, an Iub interface 320, an Iur interface 330, and/or other interfaces 340.

Processing system 310 may control the operation of radio network controller 124. As illustrated, processing system 310 may include a processing unit 312 and a memory 3 14. Processing unit 312 may handle protocol exchanges between Iub interface 320, Iur interface 330, and other interfaces 340. In addition, processing unit 312 may generate control messages and/or data messages and transmit those control messages and/or data messages via interfaces 320-340. Processing unit 312 may also process control messages and/or data messages received from interfaces 320-340. In one embodiment, processing unit 312 may include one or more processors, microprocessors, ASICs, FPGAs, or the like. Memory 314 may include a RAM, a ROM, and/or another type of memory to store data and instructions that may be used by processing unit 312.

Iub interface 320 may include one or more line cards that allow radio network controller 124 to transmit control messages and/or data messages to and receive control messages and/or data messages from base station 122. Iur interface 330 may include one or more line cards that allow radio network controller 124 to transmit control messages and/or data messages to and receive control messages and/or data messages from another radio network controller. Other interfaces 340 may include interfaces to other devices and/or networks. For example, other interfaces 340 may include an Iucs interface, which is a core network interface to a circuit-switched voice network, and an Iups interface, which is a core network interface to a packet-switched data network.

As described herein, radio network controller 124 may perform certain operations in response to processing unit 312 executing software instructions of an application contained in a computer-readable medium, such as memory 314. The software instructions may be read into memory 314 from another computer-readable medium or from another device. The software instructions contained in memory 314 may cause processing unit 312 to perform processes described herein. Alternatively, hardwired circuitry may be used in place of or in combination with software instructions to implement processes described herein. Thus, embodiments described herein are not limited to any specific combination of hardware circuitry and software.

Although FIG. 3 shows exemplary components of radio network controller 124, in other embodiments, radio network controller 124 may contain fewer, different, differently arranged, or additional components than depicted in FIG. 3. In still other embodiments, one or more components of radio network controller 124 may perform one or more other tasks described as being performed by one or more other components of radio network controller 124.

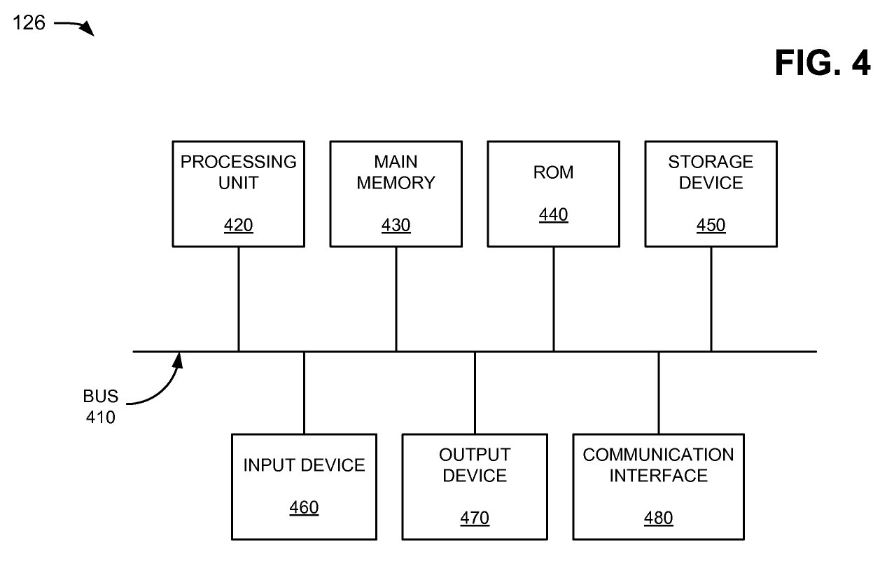

FIG. 4 illustrates a diagram of exemplary components of domain manager 126. In other embodiments, FIG. 4 may illustrate exemplary components of a device that may correspond to the OSS or the network manager described above in connection with FIG. 1. As illustrated in FIG. 4, domain manager 126 may include a bus 410, a processing unit 420, a main memory 430, a ROM 440, a storage device 450, an input device 460, an output device 470, and/or a communication interface 480. Bus 410 may include a path that permits communication among the components of device 300.

Processing unit 420 may include one or more processors, microprocessors, or other types of processors that may interpret and execute instructions. Main memory 430 may include a RAM or another type of dynamic storage device that may store information and instructions for execution by processing unit 420. ROM 440 may include a ROM device or another type of static storage device that may store static information and/or instructions for use by processing unit 420. Storage device 450 may include a magnetic and/or optical recording medium and its corresponding drive.

Input device 460 may include a mechanism that permits an operator to input information to domain manager 126, such as a keyboard, a mouse, a pen, a microphone, voice recognition and/or biometric mechanisms, a touch screen, etc. Output device 470 may include a mechanism that outputs information to the operator, including a display, a printer, a speaker, etc. Communication interface 480 may include any transceiver-like mechanism that enables domain manager 126 to communicate with other devices and/or systems. For example, communication interface 480 may include mechanisms for communicating with another device or system via a network, such as network 100.

As described herein, domain manager 126 may perform certain operations in response to processing unit 420 executing software instructions contained in a computer-readable medium, such as main memory 430. The software instructions may be read into main memory 430 from another computer-readable medium, such as storage device 450, or from another device via communication interface 480. The software instructions contained in main memory 430 may cause processing unit 420 to perform processes described herein. Alternatively, hardwired circuitry may be used in place of or in combination with software instructions to implement processes described herein. Thus, embodiments described herein are not limited to any specific combination of hardware circuitry and software.

Although FIG. 4 shows exemplary components of domain manager 126, in other embodiments, domain manager 126 may contain fewer, different, differently arranged, or additional components than depicted in FIG. 4. In still other embodiment, one or more components of domain manager 126 may perform one or more other tasks described as being performed by one or more other components of domain manager 126.

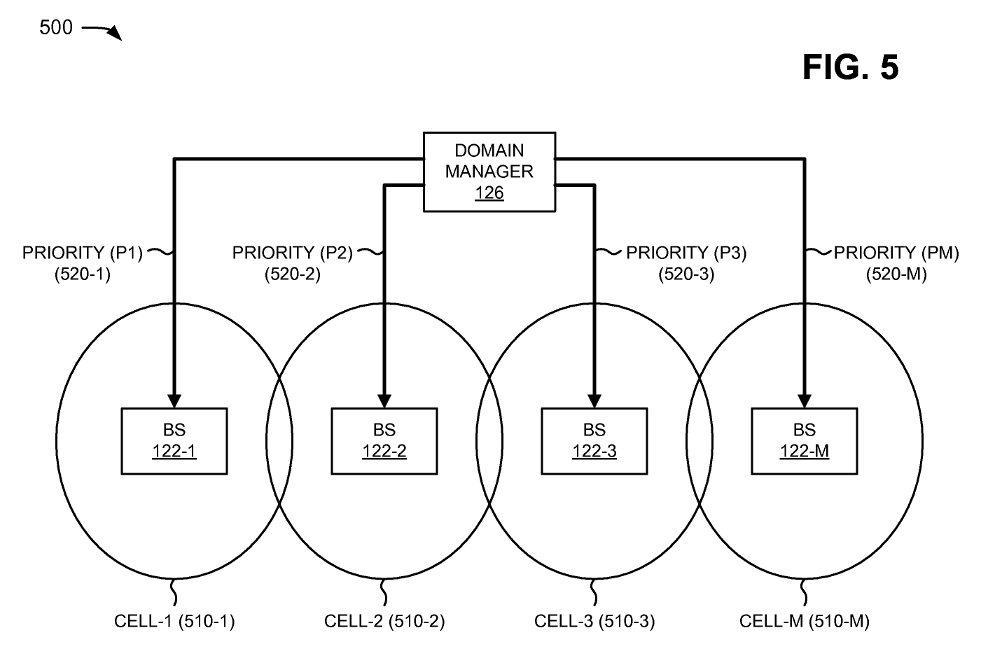

FIG. 5 depicts a diagram of exemplary interactions among components of an exemplary portion 500 of network 100. As illustrated, exemplary network portion 500 may include base stations 122-1, 122-2, 122-3, and 122-M, and domain manager 126. Base stations 122-1, 122-2, 122-3, and 122-M may include the features described above in connection with, for example, FIGS. 1 and 2. Domain manager 126 may include the features described above in connection with, for example, FIGS. 1 and 4. Alternatively, domain manager 126 may be replaced with one or more of radio network controllers 124, the OSS, and/or the network manager described above in connection with FIG. 1.

As shown in FIG. 5, base station 122-1 may provide a first cell coverage area (CELL-1) 510-1, base station 122-2 may provide a second cell coverage area (CELL-2) 510-2, base station 122-3 may provide a third cell coverage area (CELL-3) 510-3, and base station 122-M may provide another cell coverage area (CELL-M) 510-M. As further shown in FIG. 5, domain manager 126 may assign a first priority (P1) 520-1 to first cell coverage area 510-1 (e.g., to base station 122-1), may assign a second priority (P2) 520-2 to second cell coverage area 510-2 (e.g., to base station 122-2), may assign a third priority (P3) 520-3 to third cell coverage area 510-3 (e.g., to base station 122-3), and may assign another priority (PM) 520-M to other cell coverage area 510-M (e.g., to base station 122-M).

In one embodiment, first priority 520-1 may be higher than second priority 520-2, second priority 520-2 may be higher than third priority 520-3, and third priority 520-3 may be higher than other priority 520-M. In other embodiments, priorities 520-1, 520-2, 520-3, and 520-M may be ranked in varying orders. Priorities 520-1, 520-2, 520-3, and 520-M may be assigned based on a variety of factors associated with cell coverage areas 510-1, 510-2, 510-3, and 510-M. For example, if a particular cell coverage area is associated with a busy or important area (e.g., a location having a threshold volume of users, a threshold amount of service usage, or some other type of measurable criteria), such as government buildings, major business parks, transportation locations (e.g., railroad stations, airports, etc.), main highway arteries, etc., domain manager 126 may assign a priority to the particular cell coverage area that is higher than cell coverage areas associated with ordinary areas, such as less busy areas (e.g., country roads, secondary roads, residential areas, etc.).

In one embodiment, domain manager 126 may assign different priorities 520-1, 520-2, 520-3, and 520-M depending on a time of day and/or location information. For example, domain manager 126 may assign a cell (e.g., associated with a sports arena or a business park) a higher or lower priority at different times of the day (e.g., the sports arena may have a higher priority at night when a sporting event is occurring than during the day when a sporting may not be occurring).

In another embodiment, domain manager 126 may assign different priorities 520-1, 520-2, 520-3, and 520-M depending on a load associated with a cell. For example, domain manager 126 assign a heavily utilized or loaded cell a higher priority than a priority assigned to a less utilized or loaded cell (e.g., if first cell coverage area 510-1 is more heavily loaded than second cell coverage area 510-2, domain manager 126 may assign first cell coverage area 510-1 a priority that is higher than second cell coverage area 510-2).

In still another embodiment, domain manager 126 may assign different priorities 520-1, 520-2, 520-3, and 520-M based on a distance to user equipment associated with an out of service cell. For example, domain manager 126 may assign a higher priority to a cell that is further away from an out of service cell than a priority assigned to a cell that is closer to the out of service cell. Domain manager 126 may assign priorities 520-1, 520-2, 520-3, and 520-M so that distant cells from an out of service cell do not act as helper cells and that cells closest to the out of service cell act as helper cells. Domain manager 126 may determine the closest cells based on cell overlap, number of handovers being made, number of served users, subscriber information associated with the users (e.g., business users, premium users, etc.), etc.

In a further embodiment, domain manager 126 may automatically assign different priorities 520-1, 520-2, 520-3, and 520-M. For example, domain manager 126 may automatically create priorities 520-1, 520-2, 520-3, and 520-M based on traffic carried by cell coverage areas 510-1, 510-2, 510-3, and 510-M, overlap of cell coverage areas 510-1, 510-2, 510-3, and 510-M, etc. In another example, domain manager 126 may determine a final priority for a cell based on a combination of a priority automatically created by domain manager 126 and a priority defined by a network operator.

Although FIG. 5 shows exemplary components of network portion 500, in other embodiments, network portion 500 may contain fewer, different, differently arranged, or additional components than depicted in FIG. 5. In still other embodiments, one or more components of network portion 500 may perform one or more other tasks described as being performed by one or more other components of network portion 500.

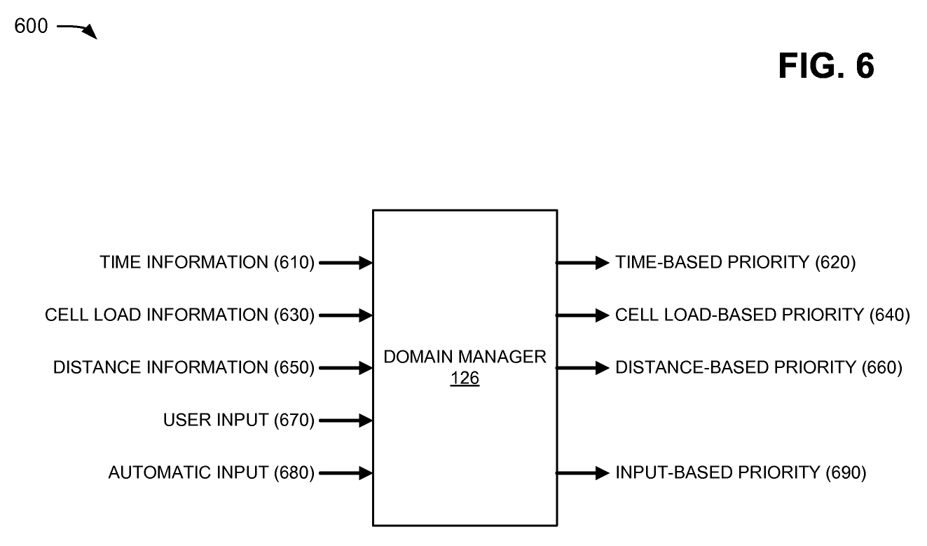

FIG. 6 illustrates a diagram of exemplary information capable of being received and/or generated by a component of an exemplary portion 600 of network 100. As illustrated, exemplary network portion 600 may include domain manager 126. Domain manager 126 may include the features described above in connection with, for example, FIGS. 1 and 4. Alternatively, domain manager 126 may be replaced with one or more of radio network controllers 124, the OSS, and/or the network manager described above in connection with FIG. 1.

As shown in FIG. 6, domain manager 126 may receive time information 610 and may generate a time-based priority 620. Time information 610 may include information associated with a day of the week, a time of day, etc. Time-based priority 620 may include a priority (e.g., assigned to a cell) that is based on time information 610. For example, domain manager 126 may assign a cell (e.g., associated with a sports arena or a business park) a higher or lower time-based priority 620 at different times of the day (e.g., the sports arena may have a higher priority at night when a sporting event is occurring than during the day when a sporting may not be occurring).

As further shown in FIG. 6, domain manager 126 may receive cell load information 630 and may generate a cell load-based priority 640 based on cell load information 630. Cell load information 630 may include information associated with resource utilization of a cell, cell traffic, etc. Cell load-based priority 640 may include a priority (e.g., assigned to a cell) that depends on a load associated with a cell. For example, domain manager 126 assign a heavily utilized or loaded cell a higher cell load-based priority 640 than a priority assigned to a less utilized or loaded cell.

As still further shown in FIG. 6, domain manager 126 may receive distance information 650 and may generate a distance-based priority 660 based on distance information 650. Distance information 650 may include information associated with distances to user equipment associated with one or more out of service cells. Domain manager 126 may determine distance information 650 based on cell overlap, number of handovers being made, number of served users, subscriber information associated with the users (e.g., business users, premium users, etc.), etc. Distance-based priority 660 may include a priority (e.g., assigned to a cell) that is based on a distance to user equipment associated with an out of service cell. For example, domain manager 126 may assign a higher distance-based priority 660 to a cell that is further away from an out of service cell than a priority assigned to a cell that is closer to the out of service cell. Domain manager 126 may assign distance-based priority 660 so that distant cells from an out of service cell do not act as helper cells and that cells closest to the out of service cell act as helper cells.

As also shown in FIG. 6, domain manager 126 may receive a user input 670 and an automatic input 680, and may generate an input-based priority 690 based on user input 670 and/or automatic input 680. User input 670 may include a priority defined by a network operator (e.g., associated with network 100 (FIG. 1)). Automatic input 680 may include a priority automatically created by domain manager 126 (e.g., based on time information 610, cell load information 630, distance information 650, traffic carried by cell coverage areas, overlap of cell coverage areas, and/or combinations of the aforementioned information). Input-based priority 690 may include a priority (e.g., assigned to a cell) that is based on a combination of the priority provided by user input 670 and the priority provided by automatic input 680. For example, domain manager 126 may determine input-based priority 690 for a cell based on a combination of a priority defined by the network operator (e.g., via user input 670) and a priority automatically created by domain manager 126 (e.g., via automatic input 680).

Although FIG. 6 shows exemplary information capable of being received and/or generated by an exemplary component of network portion 600, in other embodiments, network portion 600 may receive and/or generate less, different, or additional information than depicted in FIG. 6. For example, in one embodiment, domain manager 126 may receive business information associated with a cell (e.g., whether the cell serves government buildings, major business parks, transportation locations (e.g., railroad stations, airports, etc.), main highway arteries, etc.), and may determine a priority for the cell based on the business information. In another embodiment, domain manager 126 may receive user importance information associated with a cell (e.g., whether an important user (e.g., a president of a company, a government official, a movie star, etc. is present in a cell), and may determine a priority for the cell based on the user importance information.

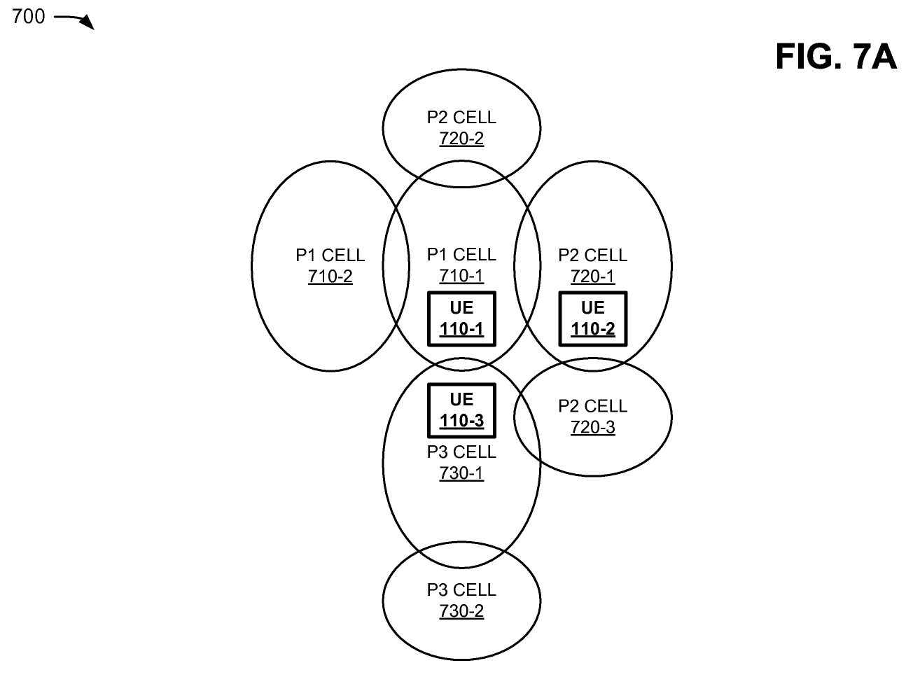

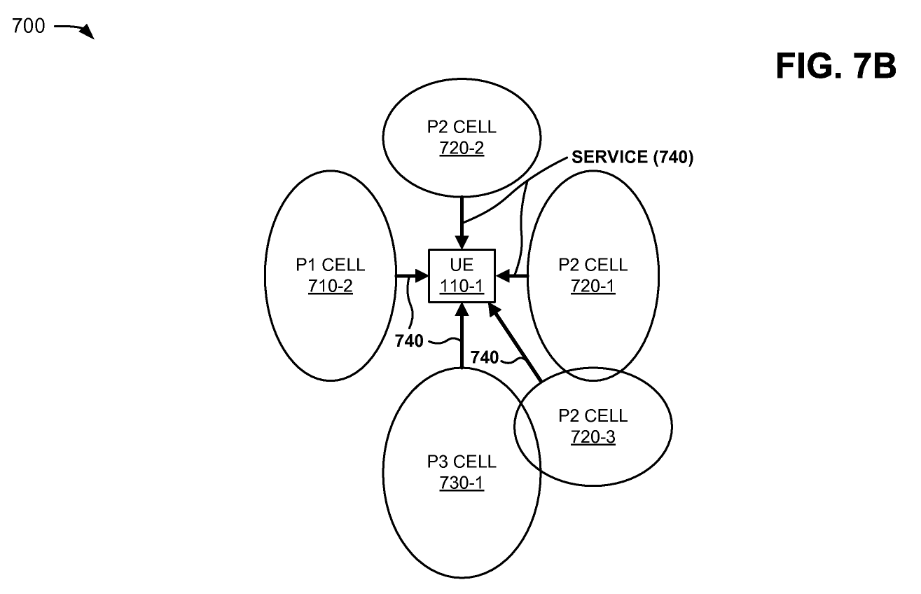

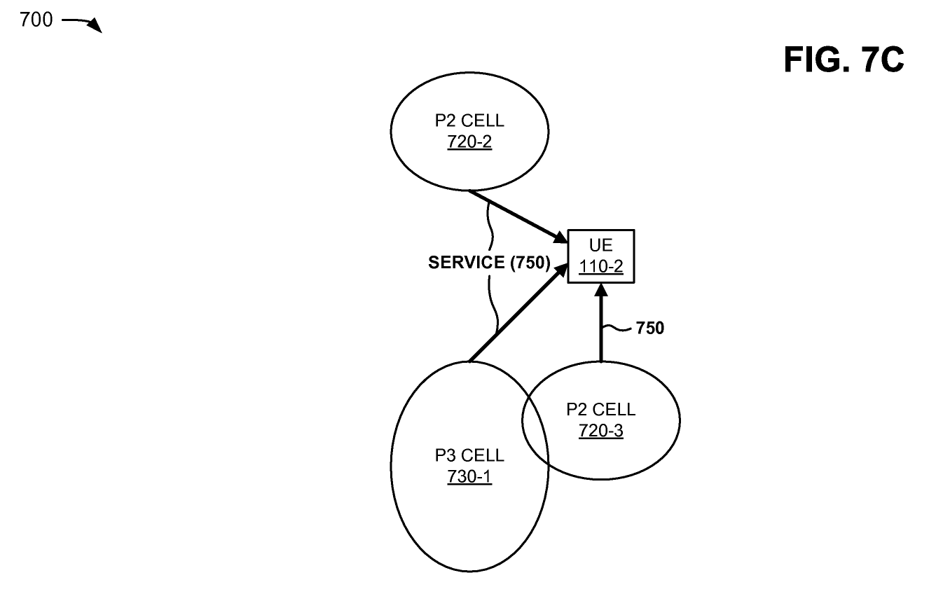

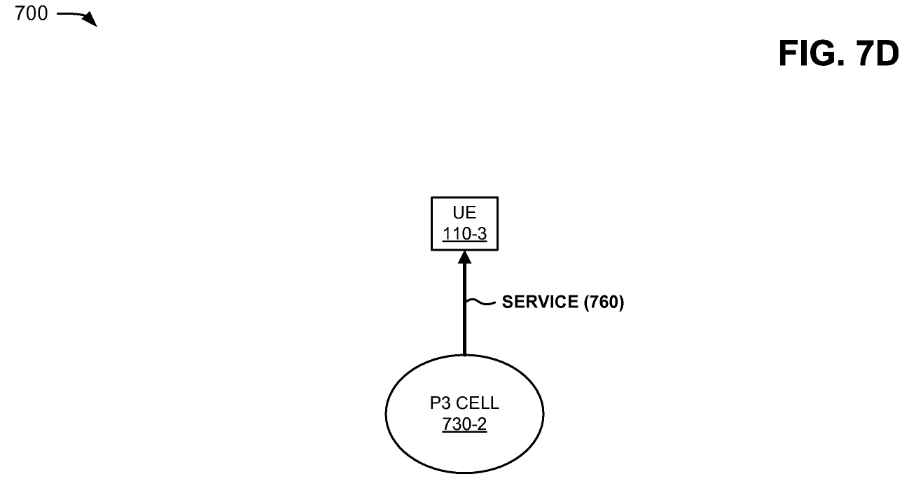

FIGS. 7A-7D depict diagrams of exemplary interactions among components of an exemplary portion 700 of network 100. As illustrated, exemplary network portion 700 may include user equipment 110-1, 110-2, and 110-3. User equipment 110-1, 110-2, and 110-3 may include the features described above in connection with, for example, FIG. 1.

As shown in FIG. 7A, user equipment 110-1 may be associated with a first priority cell coverage area (P1 CELL) 710-1, and another first priority cell coverage area (P1 CELL) 710-2 may be provided adjacent to P1 CELL 710-1. User equipment 110-2 may be associated with a second priority cell coverage area (P2 CELL) 720-1, and two other second priority cell coverage areas (P2 CELLs) 720-2 and 720-3 may be provided adjacent to P2 CELL 720-1. User equipment 110-3 may be associated with a third priority cell coverage area (P3 CELL) 730-1, and another third priority cell coverage area (P3 CELL) 730-2 may be provided adjacent to P3 CELL 730-1. In the exemplary embodiment depicted in FIGS. 7A-7D, it may be assumed that P1 CELLs 710-1 and 710-2 have a higher priority than a priority assigned to P2 CELLs 720-1, 720-2, and 720-3, and that P2 CELLs 720-1, 720-2, and 720-3 have a higher priority than a priority assigned to P3 CELLs 730-1 and 730-2. It may further be assumed that the priorities assigned to P1 CELLs 710-1 and 710-2 are equivalent, that the priorities assigned to P2 CELLs 720-1, 720-2, and 720-3 are equivalent, and that the priorities assigned to P3 CELLs 730-1 and 730-2 are equivalent.

As shown in FIG. 7B, if P1 CELL 710-1 is out of service, user equipment 110-1 may lose service since P1 CELL 710-1 is unable to serve user equipment 110-1. In one example, P1 CELL 710-1 may experience a total cell failure (e.g., where no service is received from the cell) due to loss of electrical power, transport failure, antenna failure, failure of non-redundant equipment, etc. In another example, P1 CELL 710-1 may experience a partial cell failure (e.g., where limited service is received from the cell) due to partial transport failure, reduced transmit power, loss of receiver capabilities, reduced processing capabilities, etc. In one embodiment, it may be determined that an out of service cell (e.g., P1 CELL 710-1) is unable to serve user equipment (e.g., user equipment 110-1) in its intended coverage area. The determination may be made by the out of service base station associated with P1 CELL 710-1, domain manager 126 connected to the out of service base station, and/or another node of network 100 (e.g., one of radio network controllers 124, the OSS, the network manager, etc.). When an out of service cell (e.g., P1 CELL 710-1) is determined to be unable to provide service, a set of alternative (or “helper”) cells in the vicinity of the out of service cell may be determined (e.g., by the out of service base station, one of radio network controllers 124, the OSS, the network manager, etc.) based on, for example, priorities assigned to the helper cells. For example, since user equipment 110-1 was associated with a cell having a highest priority (e.g., P1 CELL 710-1), the helper cells may include other adjacent cells having priorities less than or equal to the highest priority (e.g., P1 CELL 710-1).

As further shown in FIG. 7B, when P1 CELL 710-1 is out of service, P1 CELL 710-2, P2 CELLs 720-1, 720-2, and 720-3, and P3 CELL 730-1 may constitute the most favorable helper cells for user equipment 110-1 based on the priorities assigned to these cells and the cells' distances from user equipment 110-1. Thus, user equipment 110-1 may receive services 740 from P1 CELL 710-2, P2 CELLs 720-1, 720-2, and 720-3, and P3 CELL 730-1. Each of services 740 may include a portion of the service that was previously provided by P1 CELL 710-1. In one embodiment, the combination of services 740 provided by P1 CELL 710-2, P2 CELLs 720-1, 720-2, and 720-3, and P3 CELL 730-1 may correspond to the service that was previously provided by P1 CELL 710-1.

As shown in FIG. 7C, if P2 CELL 720-1 is out of service, user equipment 110-2 may lose service since P2 CELL 720-1 is unable to serve user equipment 110-2. In one example, P2 CELL 720-1 may experience a total cell failure (e.g., where no service is received from the cell) or a partial cell failure (e.g., where limited service is received from the cell). In one embodiment, it may be determined that an out of service cell (e.g., P2 CELL 720-1) is unable to serve user equipment (e.g., user equipment 110-2) in its intended coverage area. The determination may be made by the out of service base station associated with P2 CELL 720-1, domain manager 126 connected to the out of service base station, and/or another node of network 100 (e.g., one of radio network controllers 124, the OSS, the network manager, etc.). When an out of service cell (e.g., P2 CELL 720-1) is determined to be unable to provide service, a set of alternative (or “helper”) cells in the vicinity of the out of service cell may be determined (e.g., by the out of service base station, one of radio network controllers 124, the OSS, the network manager, etc.) based on, for example, priorities assigned to the helper cells. For example, since user equipment 110-2 was associated with a cell having a second priority (e.g., P2 CELL 720-1), the helper cells may include other adjacent cells having priorities less than or equal to the second priority (e.g., P2 CELL 720-1).

As further shown in FIG. 7C, when P2 CELL 720-1 is out of service, P2 CELLs 720-2 and 720-3 and P3 CELL 730-1 may constitute the most favorable helper cells for user equipment 110-2 based on the priorities assigned to these cells and the cells' distances from user equipment 110-2. Thus, user equipment 110-2 may receive services 750 from P2 CELLs 720-2 and 720-3 and P3 CELL 730-1. Each of services 750 may include a portion of the service that was previously provided by P2 CELL 720-1. In one embodiment, the combination of services 750 provided by P2 CELLs 720-2 and 720-3 and P3 CELL 730-1 may correspond to the service that was previously provided by P2 CELL 720-1.

As shown in FIG. 7D, if P3 CELL 730-1 is out of service, user equipment 110-3 may lose service since P3 CELL 730-1 is unable to serve user equipment 110-3. In one example, P3 CELL 730-1 may experience a total cell failure (e.g., where no service is received from the cell) or a partial cell failure (e.g., where limited service is received from the cell). In one embodiment, it may be determined that an out of service cell (e.g., P3 CELL 730-1) is unable to serve user equipment (e.g., user equipment 110-3) in its intended coverage area. The determination may be made by the out of service base station associated with P3 CELL 730-1, domain manager 126 connected to the out of service base station, and/or another node of network 100 (e.g., one of radio network controllers 124, the OSS, the network manager, etc.). When an out of service cell (e.g., P3 CELL 730-1) is determined to be unable to provide service, a set of alternative (or “helper”) cells in the vicinity of the out of service cell may be determined (e.g., by the out of service base station, one of radio network controllers 124, the OSS, the network manager, etc.) based on, for example, priorities assigned to the helper cells. For example, since user equipment 110-3 was associated with a cell having a third priority (e.g., P3 CELL 730-1), the helper cells may include other adjacent cells having priorities less than or equal to the third priority (e.g., P3 CELL 730-1).

As further shown in FIG. 7D, when P3 CELL 730-1 is out of service, P3 CELL 730-2 may constitute the most favorable helper cell for user equipment 110-3 based on the priority assigned to this cell and the cell's distances from user equipment 110-3. Thus, user equipment 110-3 may receive service 760 from P3 CELL 730-2. In one embodiment, service 760 provided by P3 CELL 730-2 may correspond to the service that was previously provided by P3 CELL 730-1.

Although FIGS. 7A-7D show exemplary components of network portion 700, in other embodiments, network portion 700 may contain fewer, different, differently arranged, or additional components than depicted in FIGS. 7A-7D. In still other embodiments, one or more components of network portion 700 may perform one or more other tasks described as being performed by one or more other components of network portion 700. In one exemplary embodiment, a high priority cell may provide temporary service to the users associated with low priority cell when the high priority cell is lightly loaded. In such a situation, the priority of the high priority cell may remain the same (e.g., in a light load situation), but network 100 (e.g., domain manager 126) may overlook the high priority so that the high priority cell may be included as a helper cell. Alternatively, network 100 (e.g., domain manager 126) may temporarily lower the priority of a lightly loaded high priority cell.

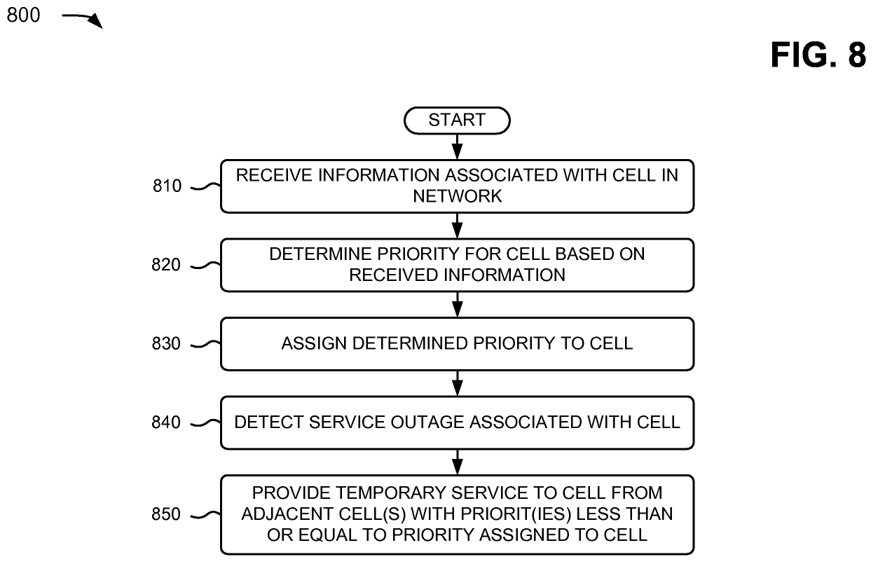

FIGS. 8-12 illustrate flow charts of an exemplary process 800 for assigning priorities to cells and for providing temporary service to out of service cells based on the assigned priorities according to embodiments described herein. In one embodiment, process 800 may be performed by an out or service base station (e.g., one of base stations 122), one of radio network controllers 124, domain manager 126, an OSS, and/or a network manager. In other embodiments, some or all of process 800 may be performed by another device or group of devices (e.g., communicating with base stations 122, radio network controllers 124, domain manager 126, the OSS, and/or the network manager).

As illustrated in FIG. 8, process 800 may begin with receipt of information associated with a cell in a network (block 810), determining a priority for the cell based on the received information (block 820), and assigning the determined priority to the cell (block 830). For example, in embodiments described above in connection with FIG. 6, domain manager 126 may receive time information 610 and may generate time-based priority 620. Time information 610 may include information associated with a day of the week, a time of day, etc. Time-based priority 620 may include a priority (e.g., assigned to a cell) that is based on time information 610. Domain manager 126 may receive cell load information 630 and may generate cell load-based priority 640 based on cell load information 630. Cell load information 630 may include information associated with resource utilization of a cell, cell traffic, etc. Cell load-based priority 640 may include a priority (e.g., assigned to a cell) that depends on a load associated with a cell. Domain manager 126 may receive distance information 650 and may generate distance-based priority 660 based on distance information 650. Distance information 650 may include information associated with distances to user equipment associated with one or more out of service cells. Distance-based priority 660 may include a priority (e.g., assigned to a cell) that is based on a distance to user equipment associated with an out of service cell.

As further shown in FIG. 8, a service outage associated with the cell may be detected (block 840), and temporary service may be provided to the cell from one or more adjacent cells with priorities less than or equal to the priority assigned to the cell (block 850). For example, in embodiments described above in connection with FIG. 7B, it may be determined that an out of service cell (e.g., P1 CELL 710-1) is unable to serve user equipment (e.g., user equipment 110-1) in its intended coverage area. The determination may be made by the out of service base station associated with P1 CELL 710-1, domain manager 126 connected to the out of service base station, and/or another node of network 100. When an out of service cell (e.g., P1 CELL 710-1) is determined to be unable to provide service, a set of alternative (or “helper”) cells in the vicinity of the out of service cell may be determined based on, for example, priorities assigned to the helper cells. Since user equipment 110-1 was associated with a cell having a highest priority (e.g., P1 CELL 710-1), the helper cells may include other adjacent cells having priorities less than or equal to the highest priority (e.g., P1 CELL 710-1). Thus, P1 CELL 710-2, P2 CELLs 720-1, 720-2, and 720-3, and P3 CELL 730-1 may constitute the most favorable helper cells for user equipment 110-1 based on the priorities assigned to these cells and the cells' distances from user equipment 110-1. Thus, user equipment 110-1 may receive services 740 from P1 CELL 710-2, P2 CELLs 720-1, 720-2, and 720-3, and P3 CELL 730-1. Each of services 740 may include a portion of the service that was previously provided by P1 CELL 710-1.

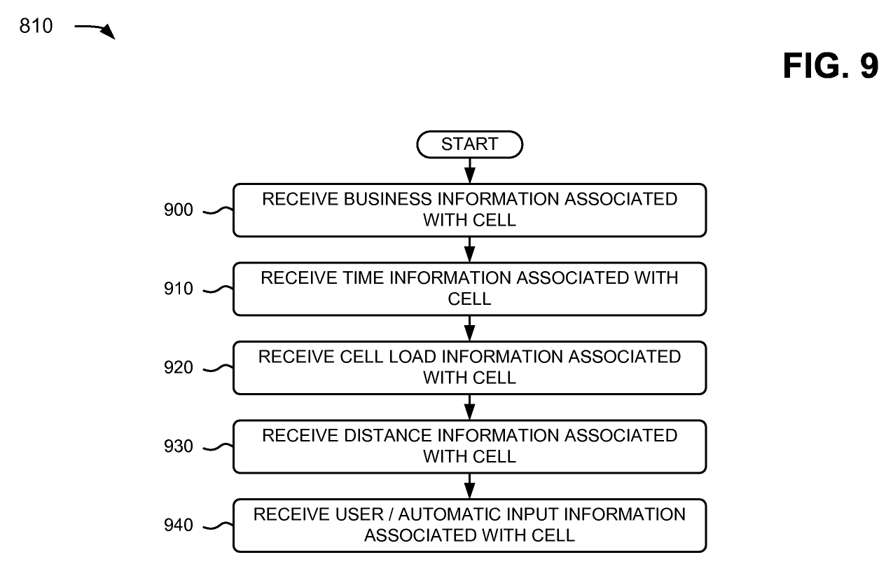

Process block 810 may include the process blocks depicted in FIG. 9. As illustrated in FIG. 9, process block 810 may include receiving business information associated with the cell (block 900), receiving time information associated with the cell (block 910), receiving cell load information associated with the cell (block 920), receiving distance information associated with the cell (block 930), and/or receive user and/or automatic input information associated with the cell (block 940). For example, in embodiments described above in connection with FIG. 6, domain manager 126 may receive business information associated with a cell (e.g., whether the cell serves government buildings, major business parks, transportation locations (e.g., railroad stations, airports, etc.), main highway arteries, etc.). Domain manager 126 may receive time information 610, which may include information associated with a day of the week, a time of day, etc. Domain manager 126 may receive cell load information 630, which may include information associated with resource utilization of a cell, cell traffic, etc. Domain manager 126 may receive distance information 650, which may include information associated with distances to user equipment associated with one or more out of service cells. Domain manager 126 may receive user input 670 and automatic input 680. User input 670 may include a priority defined by a network operator (e.g., associated with network 100 (FIG. 1)). Automatic input 680 may include a priority automatically created by domain manager 126.

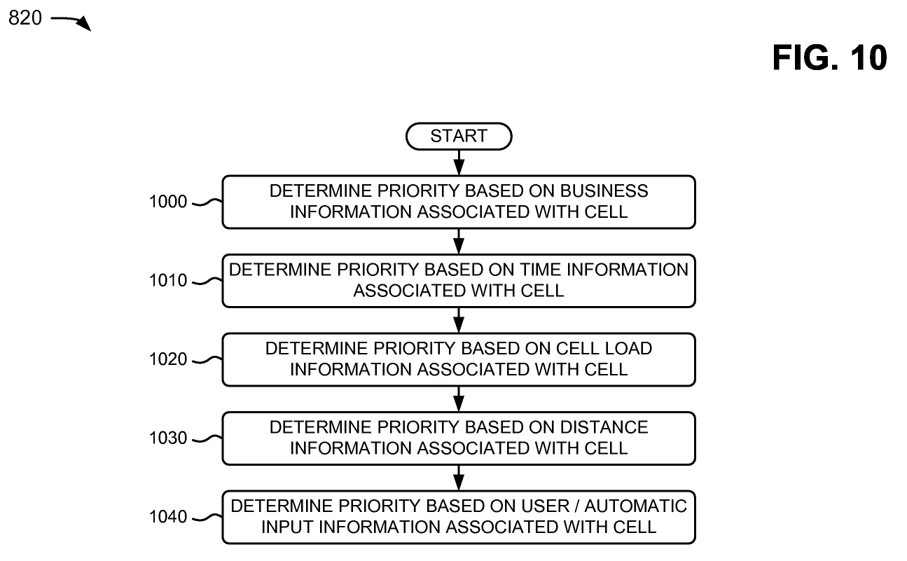

Process block 820 may include the process blocks depicted in FIG. 10. As illustrated in FIG. 10, process block 820 may include determining the priority based on business information associated with the cell (block 1000), determining the priority based on time information associated with the cell (block 1010), determining the priority based on cell load information associated with the cell (block 1020), determining the priority based on distance information associated with the cell (block 1030), and/or determining the priority based on user and/or automatic input information associated with the cell (block 1040). For example, in embodiments described above in connection with FIG. 6, domain manager 126 may determine a cell's priority based on business information associated with the cell. Domain manager 126 may generate time-based priority 620 based on time information 610. Domain manager 126 may generate cell load-based priority 640 based on cell load information 630. Domain manager 126 may generate distance-based priority 660 based on distance information 650. Domain manager 126 may generate input-based priority 690 based on user input 670 and/or automatic input 680. Domain manager 126 may determine input-based priority 690 for a cell based on a combination of a priority defined by a network operator (e.g., via user input 670) and a priority automatically created by domain manager 126 (e.g., via automatic input 680).

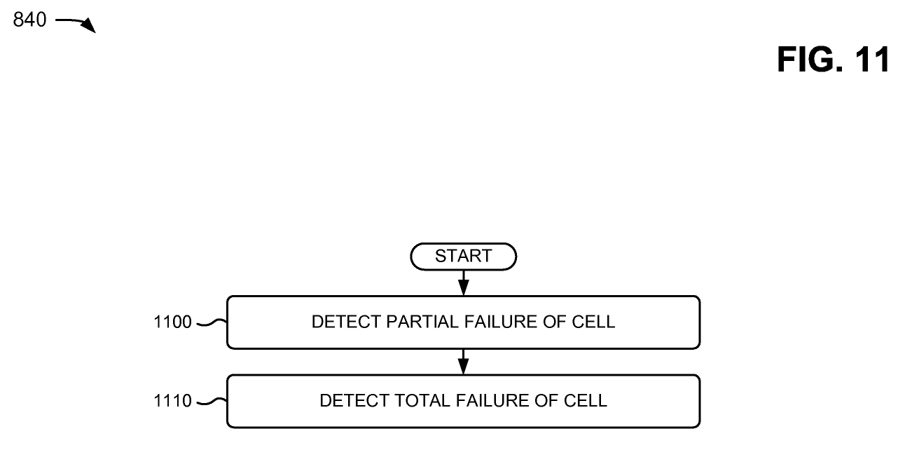

Process block 840 may include the process blocks depicted in FIG. 11. As illustrated in FIG. 11, process block 840 may include detecting a partial failure of the cell (block 1100) or detecting a total failure of the cell (block 1110). For example, in embodiments described above in connection with FIG. 7B, if P1 CELL 710-1 is out of service, user equipment 110-1 may lose service since P1 CELL 710-1 is unable to serve user equipment 110-1. In one example, P1 CELL 710-1 may experience a total cell failure (e.g., where no service is received from the cell) due to loss of electrical power, transport failure, antenna failure, failure of non-redundant equipment, etc. In another example, P1 CELL 710-1 may experience a partial cell failure (e.g., where limited service is received from the cell) due to partial transport failure, reduced transmit power, loss of receiver capabilities, reduced processing capabilities, etc.

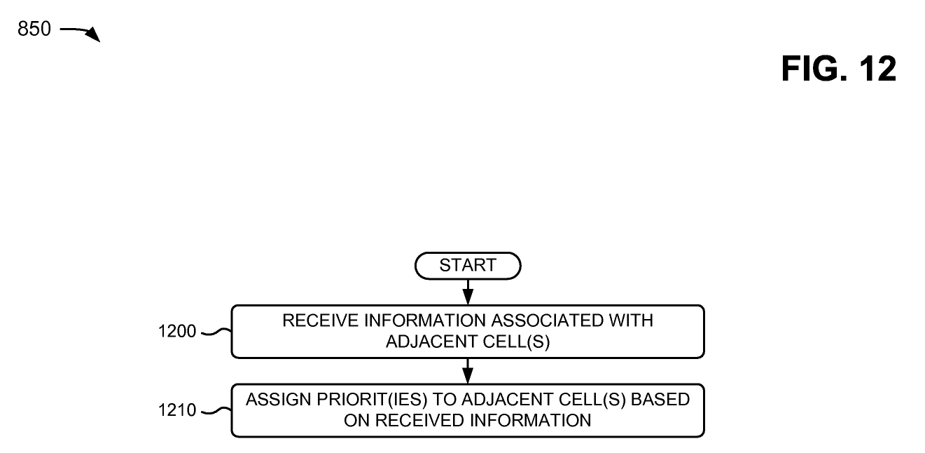

Process block 850 may include the process blocks depicted in FIG. 12. As illustrated in FIG. 12, process block 850 may include receiving information associated with the one or more adjacent cells (block 1200), and assigning priorities to the one or more adjacent cells based on the received information (block 1210). For example, in one embodiment, domain manager 126 or another node of network 100 (e.g., one of radio network controllers 124, the OSS, the network manager, etc.) may receive the information depicted in FIG. 6 (e.g., time information 610, cell load information 630, distance information 650, user input 670, automatic input 680, business information, etc.) for each of the cells associated with network 100. Domain manager 126 may assign priorities to the each of the cells associated with network 100 based on the received information.

Embodiments described herein may provide systems and/or methods that assign priorities to cells in a cellular network based on a variety of factors. The systems and/or methods may utilize two or more priority levels when assigning priorities to the cells. If a cell outage occurs, the systems and/or methods may use the assigned priorities to determine if a helper cell (e.g., assigned a priority) should attempt to serve users associated with an out of service cell (e.g., assigned a same or different priority than the helper cell). The systems and/or methods may assign a high priority to one cell of the cellular network and a low priority (e.g., lower than high priority) to another cell of the cellular network. In such an arrangement, if the high priority cell experiences a service outage, the systems and/or methods may provide temporary service, via the low priority cell, to users associated with the high priority cell. If the low priority cell experiences a service outage, the systems and/or methods may not provide temporary service, via the high priority cell, to users associated with the low priority cell. Alternatively and/or additionally, the systems and/or methods may provide temporary service, via the high priority cell, to the users associated with the low priority cell when the high priority cell is lightly loaded.

The systems and/or methods may enable a network (e.g., a cellular network) to control or limit fault propagation from an out of service cell into other cells of the network, and to automatically correct the out of service cell. By introducing cell priorities, the systems and/or methods may enable the network (and/or the network operator) to take business aspects associated with the network (e.g., certain cells may support busy and/or important areas) into account when deciding actions that may negatively impact service provided by healthy cells in the network.

The foregoing description of embodiments provides illustration and description, but is not intended to be exhaustive or to limit the invention to the precise form disclosed. Modifications and variations are possible in light of the above teachings or may be acquired from practice of the invention. For example, while a series of blocks has been described with regard to FIGS. 8-12, the order of the blocks may be modified in other embodiments. Further, non-dependent blocks may be performed in parallel.

It should be emphasized that the term “comprises/comprising” when used in this specification is taken to specify the presence of stated features, integers, steps or components but does not preclude the presence or addition of one or more other features, integers, steps, components or groups thereof.

It will be apparent that exemplary aspects, as described above, may be implemented in many different forms of software, firmware, and hardware in the embodiments illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the invention. In fact, many of these features may be combined in ways not specifically recited in the claims and/or disclosed in the specification.

No element, block, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A method in a wireless network that includes a cell and a device, the method comprising:
receiving, via the device, information associated with the cell;
determining, via a processor associated with the device, a priority for the cell based on the received information;
assigning, via the processor, the determined priority to the cell;
detecting, via the device, an outage associated with the cell; and
providing a temporary service to the cell from one or more adjacent cells with priorities less than or equal to the priority assigned to the cell.

2. The method of claim 1, where the device includes one or more of:
a domain manager,
a network manager,
a radio network controller, or
a base station.

3. The method of claim 1, where receiving, via the device, information associated with the cell includes one or more of:
receiving business information associated with the cell;
receiving time information associated with the cell;
receiving load information associated with the cell;
receiving distance information associated with the cell; or
receiving user or automatic input information associated with the cell.

4. The method of claim 3, where:
the business information includes information associated with one or more of government buildings, airports, mass transit buildings, hospitals, residential housing, industrial buildings, sports arenas, highways, or secondary roads located in the cell;
the time information includes information associated with one or more of a day of a week, a time of day, or a day of a month;
the load information includes information associated with resource utilization by the cell;
the distance information includes information associated with distances between the cell and the one or more adjacent cells;
the user input information includes priority information; and
the automatic input information includes priority information automatically generated by the device.

5. The method of claim 3, where determining, via a processor associated with the device, a priority for the cell includes one or more of:
determining the priority for the cell based on the business information;
determining the priority for the cell based on the time information;
determining the priority for the cell based on the load information;
determining the priority for the cell based on the distance information; or
determining the priority for the cell based on the user or automatic input information.

6. The method of claim 1, where detecting, via the device, an outage associated with the cell includes one of:
detecting a partial failure of the cell; or
detecting a total failure of the cell.

7. The method of claim 1, where providing a temporary service to the cell further comprises:
receiving information associated with the one or more adjacent cells; and
assigning the priorities to the one or more adjacent cells based on the information associated with the one or more adjacent cells.

8. The method of claim 1, further comprising:
providing the temporary service to the cell from one or more other adjacent cells with priorities greater than the priority assigned to the cell when resources associated with the one or more other adjacent cells are currently underutilized.

9. A device in a wireless network that includes a plurality of cells, the device comprising:
a memory to store a plurality of instructions; and
a processor to execute instructions in the memory to:
receive information associated with the plurality of cells,
determine a priority for each of the plurality of cells based on the received information,
assign each of the determined priorities to a corresponding one of the plurality of cells,
detect an outage associated with one of the plurality of cells, and
provide a temporary service to the one of the plurality of cells from one or more adjacent cells with priorities less than or equal to the priority assigned to the one of the plurality of cells.

10. The device of claim 9, where the device includes one or more of:
a domain manager,
a network manager,
a radio network controller, or
a base station.

11. The device of claim 9, where, when receiving information associated with the plurality of cells, the processor further executes instructions in the memory to one or more of:
receive business information associated with the plurality of cells,
receive time information associated with the plurality of cells,
receive load information associated with the plurality of cells,
receive distance information associated with the plurality of cells, or
receive user or automatic input information associated with the plurality of cells.

12. The device of claim 11, where:
the business information includes information associated with one or more of government buildings, airports, mass transit buildings, hospitals, residential housing, industrial buildings, sports arenas, highways, or secondary roads located in the plurality of cells,
the time information includes information associated with one or more of a day of a week, a time of day, or a day of a month,
the load information includes information associated with resource utilization by the plurality of cells,
the distance information includes information associated with distances between the plurality of cells,
the user input information includes priority information, and
the automatic input information includes priority information automatically generated by the device.

13. The device of claim 11, where, when determining a priority for each of the plurality of cells, the processor further executes instructions in the memory to one or more of:
determine the priority for each of the plurality of cells based on the business information,
determine the priority for each of the plurality of cells based on the time information,
determine the priority for each of the plurality of cells based on the load information,
determine the priority for each of the plurality of cells based on the distance information, or
determine the priority for each of the plurality of cells based on the user or automatic input information.

14. The device of claim 9, where, when detecting an outage associated with one of the plurality of cells, the processor further executes instructions in the memory to one of:
detect a partial failure of the one of the plurality of cells, or
detect a total failure of the one of the plurality of cells.

15. The device of claim 9, where, when providing a temporary service to the one of the plurality of cells, the processor further executes instructions in the memory to:
receive information associated with the one or more adjacent cells, and
provide the temporary service to the one of the plurality of cells, from the one or more adjacent cells, based on the information associated with the one or more adjacent cells.

16. The device of claim 9, where the processor further executes instructions in the memory to:
provide the temporary service to the one of the plurality of cells from one or more other adjacent cells with priorities greater than the priority assigned to the one of the plurality of cells when resources associated with the one or more other adjacent cells are currently underutilized.

17. A device in a wireless network that includes a cell, the device comprising:
means for receiving information associated with the cell;
means for determining a priority for the cell based on the received information;
means for assigning the determined priority to the cell;
means for detecting an outage associated with the cell; and
means for providing a temporary service to the cell from one or more adjacent cells with priorities less than or equal to the priority assigned to the cell.

18. The device of claim 17, where the temporary service is provided from the cell to user equipment associated with the cell.

19. The device of claim 17, further comprising:
means for receiving information associated with the one or more adjacent cells; and
means for assigning the priorities to the one or more adjacent cells based on the information associated with the one or more adjacent cells.

20. The device of claim 17, further comprising:
means for providing the temporary service to the cell from one or more other adjacent cells with priorities greater than the priority assigned to the cell when resources associated with the one or more other adjacent cells are currently underutilized.
